(19) United States
(12) Patent Application Publication
(10) Pub. No.: US 2026/0359585 A1
(43) Pub. Date: Nov. 12, 2026

(54) ELECTRONIC PAYMENT TERMINAL WITH OPTIMISED DRAINAGE OF UNWANTED LIQUID

(71) Applicant: BANKS AND ACQUIRERS INTERNATIONAL HOLDING, SURESNES (FR)

(72) Inventors: Richard ALLIROT, SURESNES (FR); Florence PANETTA, SURESNES (FR); Maxime GOULON, SURESNES (FR); Sylvain BARNERON, SURESNES (FR); Julien ROUX, SURESNES (FR)

(21) Appl. No.: 19/141,380

(22) PCT Filed: Dec. 22, 2023
(86) PCT No.: PCT/EP2023/087552

§ 371 Date: Jun. 20, 2025

(30) Foreign Application Priority Data
Dec. 23, 2022 (FR) FR2214362

(51) Int. Cl. G06K 7/00; G07F 7/08

(52) U.S. Cl. CPC G06K 7/0078; G06K 7/0091; G07F 7/0873

(57) ABSTRACT

An electronic payment terminal including a casing body in which elements for reading a payment data medium are housed. The casing body is covered at least partially with a break-in detection coating, and includes an orifice for draining undesirable liquid to the outside of the casing body. The casing body includes a security partition internal to the casing body, at least partially covered with a break-in detection coating. The security partition is interposed between the drainage orifice and a protected space of the casing body, so that the security partition forms an obstacle to the introduction of a break-in tool into the protected space.

### TECHNICAL FIELD

The invention relates to the technical field of electronic payment terminals, more particularly to assemblies comprising self-service electronic payment terminals.

### BACKGROUND

In the state of the art, an electronic payment terminal is already known, comprising a casing body in which means are housed for reading a payment data medium, for example a card fitted with an electronic chip or a magnetic stripe or both, these chip and stripe enabling data exchanges.

The casing body usually comprises a base extending between peripheral walls. One of the peripheral walls at least partly defines a slot for inserting the payment data medium into the casing body.

In order to protect the terminal against malicious break-ins, it is known to at least partially cover the casing body with a break-in detection coating. Such a coating comprises, for example, a sheet forming a flexible printed circuit, in particular known by the acronym FPC (Flexible Printed Circuit). In this type of foil, a dense network or lattice of fine conductors printed on the foil is connected to an electronic circuit which triggers an alarm as soon as damage to a conductor is detected, in particular by destruction or short-circuiting.

Typically, the break-in detection sheet has an outer portion covering an outer surface of the casing body and at least one inner portion, folded towards the inside of the casing body, at least partially covering inner surfaces of the peripheral walls.

The break-in detection coating thus makes it possible to detect any malicious drilling of the casing body intended to allow fraudulent access to sensitive information conductors.

It is known to place an assembly comprising a self-service electronic payment terminal. In some cases, particularly when the payment terminal is in the open air, this terminal may be subjected to undesirable liquid splashes, particularly if it is placed near an installation that splashes water, for example a car wash installation. Unwanted liquid splashes can therefore penetrate inside the casing body by passing through the slot for inserting the payment data medium.

Any unwanted liquid that accidentally enters the casing should be removed as far as possible. If this liquid is allowed to stagnate in the casing, it can damage the electronic circuits it contains and in particular an inner part of the break-in detection sheet, which can trigger an unintentional alarm.

Some payment terminals include one or more drainage channels. However, when the drainage device has a channel, this regularly tends to become blocked, for example as a result of the accumulation of sludge and/or dirt, impairing or even completely preventing the drainage of unwanted liquid from the casing.

To facilitate drainage of unwanted liquid, the casing body generally has an orifice for draining unwanted liquid to the outside of the casing, formed in a base of this casing body.

However, the dimensions of the drainage orifice must remain limited to prevent a protected area of the casing from being reached by inserting a break-in tool through the drainage orifice.

However, it has been observed that the more the dimensions of the drainage orifice are limited to promote security, the more difficult it is to evacuate an undesirable liquid that has unintentionally penetrated the casing body.

In particular, the aim of the invention is to promote the draining of an undesirable liquid that has penetrated the body of the casing of an electronic payment terminal, without reducing the security of this casing against malicious break-ins.

### SUMMARY

To this end, the subject of the invention is an electronic payment terminal comprising a casing body in which means for reading a payment data medium are housed, the casing body being covered at least partially with a break-in detection coating, and comprising an orifice for draining undesirable liquid to the outside of the casing body. The casing body comprises a security partition internal to the casing body, at least partially covered with a break-in detection coating. The security partition is interposed between the drainage orifice and a protected space of the casing body, so that the security partition forms an obstacle to the introduction of a break-in tool into the protected space.

Thanks to the obstacle formed by the security partition inside the casing body, at least partially covered by the break-in detection coating, the introduction of a break-in tool into the protected space is very effectively limited. In this way, the unwanted liquid drainage orifice can be made large enough to ensure effective liquid drainage.

According to other optional features of the electronic payment terminal, taken alone or in combination:
An orifice for the passage of undesirable liquid is provided through the security partition, and the drainage and passage orifices are offset from one another. The orifice for the passage of undesirable liquid further facilitates the removal of unwanted liquid. However, to ensure that the orifice for the passage does not reduce the effectiveness of the security partition, the drainage and passage orifices are offset from each other.
The profile of the edge of the orifice chosen from the drainage orifice and the passage orifice has a flared shape limiting the retention of drops of undesirable liquid.
At least one ramp for channelling unwanted liquid is formed in an inner surface of the casing body. Unwanted liquid is thus channelled to the drainage orifice by gravity when the payment terminal is in its usual position of use.
The casing body comprises a base extending between peripheral walls, the security partition forming a bracket substantially parallel to the base, connected to at least one of the peripheral walls and having at least one free edge.
The drainage orifice is formed at the junction of the base and one of the peripheral walls.
The break-in detection coating intended to cover an element chosen from the casing body and the security partition comprises a flexible printed circuit sheet, referred to as a break-in detection sheet, preferably one and the same break-in detection sheet covering the casing body and the security partition.
The break-in detection sheet at least partially covering the casing body comprises an outer portion at least partially covering an outer surface of the casing body and at least one inner portion, folded towards the inside of the casing body, at least partially covering at least one of the peripheral walls.
At least one of the peripheral walls comprises a free edge for supporting a rigid assembly comprising a printed circuit, the free supporting edge comprising at least one so-called latching projection forming both a bearing stop for the rigid assembly and a latching button on the casing body of the sheet forming a break-in detection sheet, this latching projection cooperating by nesting with a buttonhole formed in the break-in detection sheet.

It is easier to mould the latching projection on the free edge of a peripheral wall of the casing body than on an inner surface of this peripheral wall. It is not necessary to provide a movable part in the mould, forming a wedge or drawer, in order to demould the latching projection formed on the free edge. It is therefore possible to limit the number of movable parts forming wedges or drawers in a mould for manufacturing the casing body, enabling the casing body to be demoulded.

The free edge of a peripheral wall forming a support for the rigid printed circuit assembly, the height of the latching projection is preferably limited. However, despite the low height of the hooking projection, in the event of traction being exerted on the break-in detection sheet with a view to fraudulently extracting part or all of this sheet, there is no risk of the latching projection disengaging from the buttonhole into which it is fitted without damaging the break-in detection sheet. This is because the break-in detection sheet is clamped between the rigid printed circuit assembly and the free edge of the peripheral wall, so that it is not possible to separate the break-in detection sheet without destroying the buttonhole through which the latching projection extends.
The latching projection has a bearing face of the rigid assembly comprising the printed circuit substantially flush with an external surface of the break-in detection sheet. In this way, both the break-in detection sheet, clamped between the rigid assembly comprising the printed circuit and the free edge of the peripheral wall of the casing body, and the latching projection prevent any fraudulent tool from being introduced between the free edge and the rigid assembly mounted so as to bear against the free edge. In addition, despite the low height of the latching projection, in the event of fraudulent traction on the sheet, there is no risk of the latching projection disengaging from the corresponding buttonhole without damaging the sheet. This is because the sheet is clamped between the rigid assembly and the free edge, so that it is not possible to extract the sheet without destroying a buttonhole.
The security partition has a first face facing the drainage hole and a second face, opposite the first face, facing the protected space of the body of the casing.
The security partition is arranged so that the drainage orifice allows the drainage of undesirable liquid into the body of the casing by providing a sufficient drainage space between the drainage orifice and the first face of the security partition.

The invention also relates to an assembly comprising a self-service electronic payment terminal, wherein the electronic payment terminal is as defined above.

### BRIEF DESCRIPTION OF THE FIGURES

The invention will be better understood on reading the following description, which is given by way of example only and with reference to the attached drawings in which:

FIG. 1 is a perspective view of an assembly according to the invention comprising an electronic payment terminal;

FIG. 2 is a top perspective view of part of the electronic payment terminal according to the invention, showing a rigid assembly comprising a printed circuit covering a casing body of the terminal in which means for reading a payment data medium are housed;

FIG. 3 is a perspective view from below of the part of the electronic payment terminal shown in FIG. 2;

FIG. 4 is a perspective view of the part of the electronic payment terminal shown in FIG. 3, in which the casing body has been removed;

FIG. 5 is a perspective view of the inside of the casing body;

FIG. 6 is a detailed perspective view of the inside of the casing body showing an undesirable liquid passage orifice formed through a security partition;

FIG. 7 is a detailed perspective view of the rigid printed circuit assembly covering the terminal casing body, showing latching projections each forming both a support stop for the rigid assembly and an attachment button on the casing body for a break-in detection sheet forming a printed circuit.

### DETAILED DESCRIPTION

FIG. 1 shows an assembly according to the invention, designated by the general reference 10, comprising an electronic payment terminal 12. This assembly 10 comprises a fixed support, a wall 14 of which is shown separating a space EI inside the support, generally not visible to a user of the payment terminal 12, from a space EE outside the support.

In a manner known per se, the payment terminal 12 comprises a plate 16 for mounting to the wall 14 of the support carrying an interface 18 for a user accessible from the external space EE. The interface 18 comprises in particular a keyboard 20 and an opening 22 for inserting a conventional payment data medium into the payment terminal 12, for example a card fitted with an electronic chip or a magnetic stripe or both. Both the electronic chip and the magnetic stripe enable data exchanges.

The part of the payment terminal 12 intended to extend into the interior space EI comprises a casing body 24 in which conventional means of reading the payment data medium are housed.

More particularly, the means for reading the payment data medium, as well as other sensitive electronic means, are arranged in a protected space extending inside the body of the casing 24.

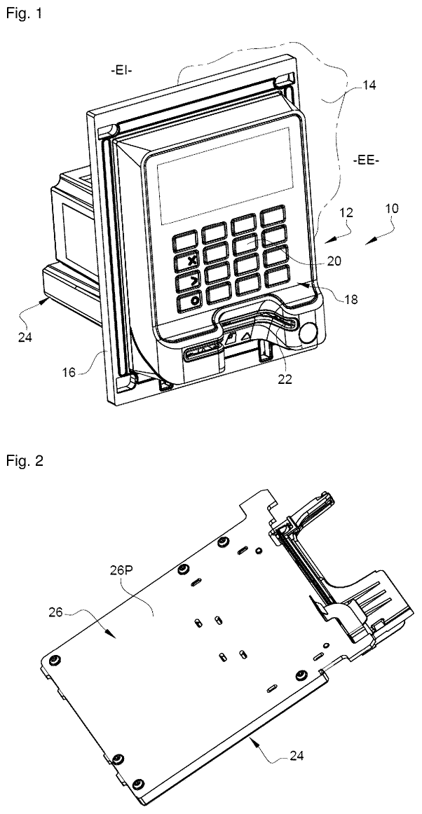

As can be seen from FIGS. 2 to 4, the part of the payment terminal 12 extending into the interior space El also comprises a conventional rigid assembly, including a printed circuit, known as a rigid printed circuit assembly 26.

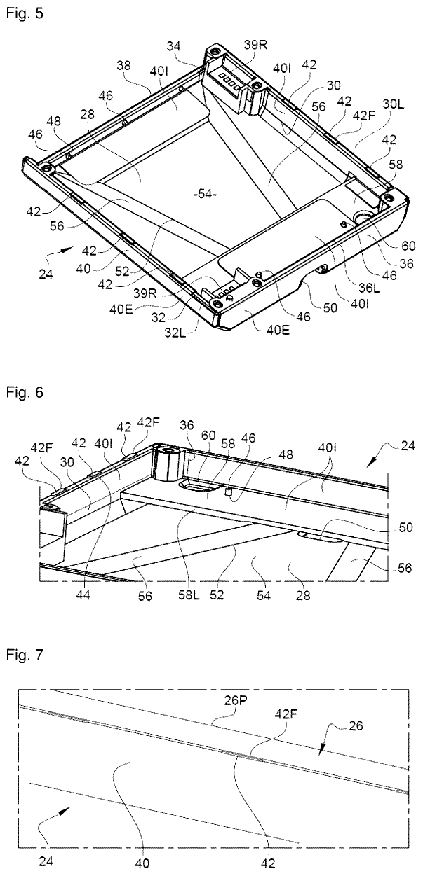

The housing body 24 is manufactured by moulding in a material preferably comprising plastic. As can be seen in particular in FIGS. 5 and 6, the casing body 24 preferably has a generally flattened shape and comprises a base 28 extending between peripheral walls. These peripheral walls comprise first 30 and second 32 opposite peripheral walls, joined together by first 34 and second 36 opposite end walls.

It should be noted that the opposite peripheral walls 30, 32 are substantially straight and parallel to each other. Similarly, the opposite end walls 34, 36 are substantially straight and parallel to each other.

The first end wall 34 defines, at least in part, a slot 38 for insertion into the casing body 24 of the payment data medium.

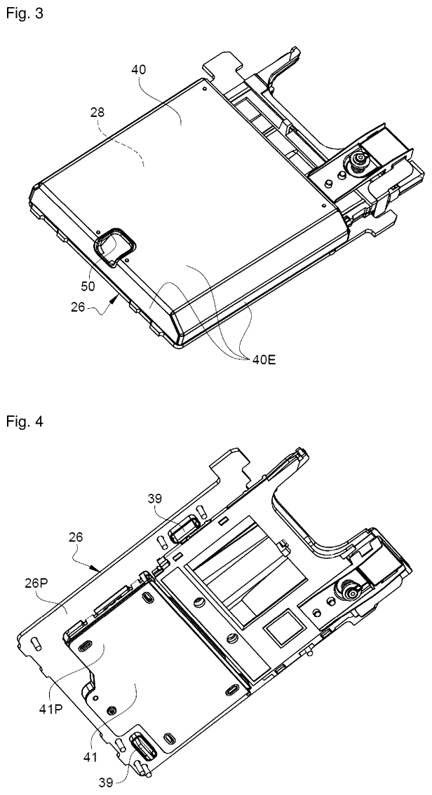

As can be seen in particular in FIGS. 3, 5 and 6, the casing body 24 is at least partially covered with a break-in detection coating. Preferably, this break-in detection coating is formed by at least one sheet forming a flexible printed circuit, known in particular by the acronym FPC (Flexible Printed Circuit). In this type of sheet, a dense network or lattice of fine conductors printed on the sheet is connected in a manner known per se to an electronic circuit triggering an alarm as soon as damage to a conductor is detected, in particular by destruction or short-circuiting.

In the example described, the break-in detection coating is formed by one and the same sheet 40 forming a flexible printed circuit.

This sheet 40 comprises an outer part 40E at least partially covering the outer surfaces of the casing body 24, namely the outer surfaces of the base 28 and the peripheral walls, more particularly the peripheral walls 30, 32 and the end walls 34, 36 (see in particular FIG. 3). The sheet 40 also comprises an inner part 401, folded towards the interior of the casing body 24, at least partially covering inner surfaces of the casing body 24, namely inner surfaces of the base 28 and the peripheral walls, more particularly peripheral 32, and end walls 34, 36 (see in particular FIG. 5).

The rigid printed circuit assembly 26 is mounted in a manner known per se against free edges 30L, 32L, 36L of the peripheral walls 30, 32 and at least the second end wall 36, for example by screwing.

In order to detect in particular a break-in tending to separate the rigid assembly 26 from the casing body 24, at least one deformable connector 39 known per se, comprising conductive layers extending in an elastomer matrix, is arranged slightly in compression between the casing body 24 and the rigid printed circuit assembly 26. The payment terminal 12 may include, for example, two deformable connectors 39 (see FIG. 4), each connector 39 being electrically connected to an electronic break-in detection circuit by conventional electrical connection means 39R as shown in FIG. 5.

The rigid printed circuit assembly 26 comprises a support 26P in the general form of a plate, the faces of which are preferably covered at least partially with a break-in detection coating formed by at least one sheet of the same type as the sheet 40.

As can be seen in FIG. 4, the payment terminal 12 may comprise an additional rigid assembly 41, comprising a support 41P in the general form of a plate, the faces of which are also at least partially covered with a break-in detection coating of the same type as the sheet 40.

The supports 26P and 41P of the rigid assemblies 26 and 41 are substantially parallel to each other. The protected space inside the casing body 24 comprises the space extending between the supports 26P and 41P. The means for reading the payment data medium are housed between the supports 26P and 41P, so as to extend into the protected space.

In order to ensure that any attempt to extract the break-in detection sheet 40 causes damage to a conductor of this sheet 40 and thus triggers an alarm, the inner part 401 of the sheet 40 is hooked onto the casing body 24 in particular by means of latching projections, integral with inner surfaces of the casing body 24, cooperating with buttonholes formed in the inner part of the sheet 40. These buttonholes are formed by holes made in the inner part of the sheet 40 through which the latching projections are fitted. The fraudulent traction exerted on the sheet 40 causes the tearing of at least one buttonhole and therefore the destruction of at least one conductor of the sheet, which leads to an alarm being triggered.

Referring in particular to FIGS. 5 and 6, it can be seen that a free edge of at least one peripheral wall, preferably the free edge 30L, 32L of the two peripheral walls 30, 32, is provided with three latching projections 42.

Each latching projection 42 forms both a latching button on the casing body 24 of the sheet 40 forming the printed circuit (see FIGS. 5 and 6) and an abutment for the rigid printed circuit assembly 26 (see FIG. 7). Each latching projection 42 cooperates by nesting with a buttonhole 44 formed in the printed circuit sheet 40 (see FIG. 6).

Of course, it is possible to provide, for each free edge 30L, 32L of the peripheral wall, a number greater or less than three latching projections 42. Where appropriate, each free edge 30L, 32L may comprise a single latching projection 42.

Referring in particular to FIGS. 5 to 7, it can be seen that each latching projection 42 comprises a face 42F for bearing the rigid assembly 26 against the free edges 30L, 32L of the peripheral walls of the casing body 24.

It should be noted that the bearing face 42F of each latching projection 42 has a generally rectangular shape delimited by long sides substantially parallel to the opposite peripheral walls 30, 32.

As the free edges 30L, 32L of the peripheral walls 30, 32 form supports for the rigid printed circuit assembly 26, the height of the latching projections 42 is preferably limited. Advantageously, this height is substantially equal to the thickness of the break-SUBSTITUTE in detection sheet 40. Thus, the bearing face 42F of each projection 42 is substantially flush with an external surface of the printed circuit sheet 40.

It should therefore be noted that both the sheet 40, clamped between the rigid assembly 26 and the free edges 30L, 32L of the peripheral walls 30, 32, and the projections 42 prevent any fraudulent tool from being introduced between the free edges 30L, 32L and the rigid assembly 26 mounted so as to bear against these free edges 30L, 32L.

Furthermore, despite the low height of the latching projections 42, in the event of fraudulent traction on the sheet 40, there is no risk of a latching projection 42 disengaging from the corresponding buttonhole 44 without damaging the sheet 40. This is because the sheet 40 is clamped between the rigid assembly 26 and each free edge 30L, 32L, so that it is not possible to extract the sheet 40 without destroying a buttonhole 44.

Even if it were imagined that a malevolent action managed to move the rigid assembly 26 away from the free edge 30L, 32L of at least one peripheral wall 30, 32, so as to allow latching projections 42 to be disengaged from their corresponding buttonholes 44 without damaging the sheet 40, at least one deformable connector 39 arranged between the casing body 24 and the rigid printed circuit assembly 26 would detect the break-in, which would trigger an alarm.

It should be noted that the payment terminal 12 may comprise means other than the latching projections 42 for attaching the inner part 401 of the sheet 40 to the casing body 24. Thus, for example, as can be seen in FIG. 5, latching projections 46, forming studs substantially perpendicular to an inner face of the first end wall 34 and integral with this wall 34, cooperate with buttonholes 48 formed in the inner part 401 of the sheet 40.

With regard to break-in detection, the latching projections 46 and buttonholes 48 have similar functions to those of the latching projections 42 and buttonholes 44.

The assembly 10 comprising the payment terminal 12 can be installed, for example, in a self-service area accessible to the public. In particular, if the assembly 10 is placed in the open air, it may be subject to the splashing of undesirable liquids, for example water. When splashes of undesirable liquid penetrate inside the casing body 24, passing through the opening 22 and the slot 38 for insertion of the payment data medium, it is advisable to allow this undesirable liquid to drain outside the casing body.

To this end, referring in particular to FIGS. 3, 5 and 6, it can be seen that the casing body 24 has an orifice 50 for draining unwanted liquid to the outside of the casing body 24.

Preferably, the drainage orifice 50 is formed at the junction of the base 28 and one of the peripheral walls, namely, in the example shown, the second end wall 36.

Preferably also, at least one ramp for channelling unwanted liquid is provided in an inner surface of the casing body 24. Thus, as can be seen in FIGS. 5 and 6, a channel 52 delimited by ramps 54, 56, of appropriate inclinations, formed in the inner surface of the base 28, enables an undesirable liquid to be channelled towards the drainage orifice 50, this by gravity when the payment terminal is in a usual position of use.

In order to very effectively limit the introduction of a break-in tool into the protected space extending inside the casing body 24, this casing body 24 comprises a security partition 58 internal to the casing body 24, interposed between the drainage orifice 50 and the protected space of the casing body 24. In this example, the security partition 58 has a first face facing the drainage orifice 50 and a second face, opposite the first face, and situated facing the protected space of the body of the casing 24, and is arranged so that the drainage orifice 50 allows the drainage of undesirable liquid into the body of the casing 24 by providing a sufficient drainage space between the drainage orifice 50 and the first face of the security partition 58. The security partition 58, extending inside the body of the casing 24, is covered, at least partially, with a break-in detection coating. In this way, the security partition 58 forms an obstacle to the introduction of a break-in tool into the protected space.

Preferably, the break-in detection coating covering the security partition 58 is formed by at least one sheet forming a flexible printed circuit, of the same type as the sheet 40. Also preferably, it is one and the same sheet 40 which covers the casing body 24 and the security partition 58. Indeed, referring to FIGS. 5 and 6, it can be seen that it is the inner part 401 of the sheet 40, folded towards the inside of the casing body 24, which covers both the inner surface of the second end wall 36 and the security partition 58.

With particular reference to FIG. 6, it can be seen that the security partition 58 forms a bracket substantially parallel to the base 28, connected to at least one of the peripheral walls. In the example shown, the security partition 58 is connected to the second end wall 36 and to the two peripheral walls 30, 32 and has a free edge 58L extending between two peripheral walls 30, 32.

To help fasten the inner part 401 of the sheet 40 to the security partition 58, latching pins 46, forming studs substantially perpendicular to one face of the security partition 58 delimiting the protected space and integral with this partition 58, cooperate with buttonholes 48 formed in the inner part 401 of the sheet 40 (see FIGS. 5 and 6).

With regard to break-in detection, the latching pins 46 carried by the security partition 58 and the corresponding buttonholes 48 have similar functions to those of the latching projections 42 and the buttonholes 44.

To further facilitate the drainage of an undesirable liquid which has accidentally penetrated the casing body 24 to the outside of this body 24, an orifice 60 for the passage of undesirable liquid is provided through the security partition 58. However, to ensure that this passage orifice 60 does not reduce the effectiveness of the security partition 58, the drainage orifices 50 and passage orifices 60 are offset from each other.

Preferably, the profile of the edge of the drainage orifice 50 and the profile of the edge of the passage orifice 60 each have a flared shape limiting the retention of undesirable drops of liquid. If necessary, only the drainage orifice 50 or the passage orifice 60 has an edge with a flared profile.

The invention is not limited to the embodiment shown and other embodiments will be clear to the person skilled in the art.

### List of References

10: Assembly comprising a payment terminal
12: Electronic payment terminal
14: Fixed support wall
EI: Internal space of the support
EE: External space of the support
16: Support mounting plate
18: User interface
20: Keyboard
22: Opening for insertion of payment data medium
24: Casing body
26: Rigid printed circuit assembly
26P: Rigid printed circuit assembly support
28: Casing base
30: First peripheral wall
30L: Free edge of first side panel
32: Second peripheral wall
32L: Free edge of second peripheral wall
34: First end wall
34L: Free edge of first end wall
36: Second end wall
36L: Free edge of second end wall
38: Slot for insertion into casing body
39: Deformable connector
39R: Connection means
40: Break-in detection coating sheet
40E: Outer part of the coating sheet
401: Inner part of the coating sheet
41: Additional rigid assembly
41P: Additional rigid assembly support
42: Latching projection
42F: Bearing face of the latching projection
44: Buttonhole
46: Latching pin
48: Buttonhole for hanging stud
50: Draining orifice
52: Channel
54, 56: ramp
58: Security partition
58L: Free edge of security partition
60: Passage orifice

1. An electronic payment terminal comprising:
a casing body wherein means for reading a payment data medium are housed, the casing body being covered at least partially with a break-in detection coating, and comprising a drainage orifice for draining undesirable liquid to an outside of the casing body,
wherein the casing body comprises a security partition internal to the casing body, covered at least partially with a break-in detection coating, the security partition being interposed between the drainage orifice and a protected space of the casing body, so that the security partition forms an obstacle to an introduction of a break-in tool into the protected space.

2. The electronic payment terminal according to claim 1, wherein an a passage orifice for passage of undesirable liquid is provided through the security partition, the drainage orifice and the passage orifice being offset from one another.

3. The electronic payment terminal according to claim 2, wherein a profile of an edge of one of the drainage orifice or the passage orifice has a flared shape limiting retention of drops of undesirable liquid.

4. The electronic payment terminal according to claim 3, wherein at least one ramp for channelling unwanted liquid is formed in an inner surface of the casing body.

5. The electronic payment terminal according to claim 4, wherein the casing body comprises a base extending between peripheral walls, the security partition forming a bracket substantially parallel to the base, connected to at least one of the peripheral walls and comprising at least one free edge.

6. The electronic payment terminal according to claim 5, wherein the drainage orifice is formed at a junction of the base and one of the peripheral walls.

7. The electronic payment terminal according to claim 6, wherein the break-in detection coating intended to cover an element chosen from the casing body and the security partition comprises a break-in detection sheet forming a flexible printed circuit.

8. The electronic payment terminal according to claim 7, wherein the break-in detection sheet at least partially covering the casing body comprises an outer part at least partially covering an outer surface of the casing body and at least one inner part, folded towards an inside of the casing body, at least partially covering at least one of the peripheral walls.

9. The electronic payment terminal according to claim 8, wherein at least one of the peripheral walls comprises a free edge for supporting a rigid assembly comprising a printed circuit, the free edge comprising at least one latching projection forming both a bearing stop for the rigid assembly and a latching button on the casing body of the a break-in detection sheet, this latching projection cooperating by nesting with a buttonhole formed in the break-in detection sheet.

10. The electronic payment terminal according to claim 9, wherein the latching projection comprises a bearing face of the rigid assembly comprising the printed circuit, substantially flush with an external surface of the break-in detection sheet.

11. An assembly comprising a self-service electronic payment terminal, wherein the electronic payment terminal is according to claim 1.

12. The electronic payment terminal according to claim 7, wherein the break-in detection sheet covers the casing body and the security partition.

13. The electronic payment terminal according to claim 1, wherein at least one ramp for channelling unwanted liquid is formed in an inner surface of the casing body.

14. The electronic payment terminal according to claim 1, wherein the casing body comprises a base extending between peripheral walls, the security partition forming a bracket substantially parallel to the base, connected to at least one of the peripheral walls and comprising at least one free edge.

15. The electronic payment terminal according to claim 1, wherein the break-in detection coating intended to cover an element chosen from the casing body and the security partition comprises a break-in detection sheet forming a flexible printed circuit.

16. The electronic payment terminal according to claim 15, wherein the break-in detection sheet covers the casing body and the security partition.

17. The electronic payment terminal according to claim 15, wherein the casing body comprises a base extending between peripheral walls, the security partition forming a bracket substantially parallel to the base, connected to at least one of the peripheral walls and comprising at least one free edge, and wherein the break-in detection sheet at least partially covering the casing body comprises an outer part at least partially covering an outer surface of the casing body and at least one inner part, folded towards an inside of the casing body, at least partially covering at least one of the peripheral walls.
